(19) United States
(12) Patent Application Publication
(10) Pub. No.: US 2013/0240142 A1
(43) Pub. Date: Sep. 19, 2013

(54) ISOLATION BETWEEN A BAFFLE PLATE AND A FOCUS ADAPTER

(71) Applicants: Tseh Lih Foo, Singapore (SG); Kin Wei Chia, Singapore (SG)

(72) Inventors: Tseh Lih Foo, Singapore (SG); Kin Wei Chia, Singapore (SG)

(73) Assignee: GLOBALFOUNDRIES Singapore Pte. Ltd., Singapore (SG)

(21) Appl. No.: 13/420,769

(22) Filed: Mar. 15, 2012

(51) Int. Cl. C23F 1/08; B32B 37/12; B23P 11/00

(52) U.S. Cl. 156/345.1; 29/428; 156/299; 29/407.1

(57) ABSTRACT

A device is provided for preventing contact between a baffle plate and a focus adapter in the upper chamber of an ashing system. The device includes a housing, a baffle plate including a plurality of holes, a focus adapter between the housing and the baffle plate, a plurality of spacers aligned with the holes, and a plurality of fasteners securing the spacers between the baffle plate and the housing, wherein the spacers isolate the focus adapter from contacting the baffle plate.

### TECHNICAL FIELD

The present disclosure relates to semiconductor wafer fabrication systems. The present disclosure is particularly applicable to ashing systems used in the manufacturing of semiconductor wafers.

### BACKGROUND

Plasma ashing systems have been designed for front-end-of-line (FEOL) and back-end-of-line (BEOL) photoresist removal from semiconductor wafers. In such systems, a plasma source is used to generate a monatomic reactive species which combines with the photoresist to form ash, which is removed with a vacuum pump. An upper chamber of an ashing system includes a quartz focus adapter and an aluminum baffle plate, which are in contact with each other. During wafer processing, the chamber pressure transitions from atmospheric pressure to vacuum and back to atmospheric pressure for each wafer process. The frequent changes in pressure cause the focus adapter to move up and down. The friction from the contact between the focus adapter and the baffle plate during the pressure transitions and the vacuum state generates small particles. Current waferless auto dry clean and idle conditioning can minimize particle generation but cannot prevent the friction between the baffle plate and the focus adapter caused by changes in pressure. Thus, the friction and the particles reduce the mean time between cleans and the lifetime of the baffle plates while increasing yield defect density highlights and costs.

A need therefore exists for a method and a device for isolating the focus adapter from the baffle plate during wafer processing.

### SUMMARY

An aspect of the present disclosure is a device that prevents friction between a baffle plate and a focus adapter within an ashing system during wafer processing.

Another aspect of the present disclosure is a method to prevent a baffle plate and a focus adapter from contacting during wafer processing.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a device including: a focus adapter; a baffle plate having a plurality of holes positioned around an edge of the baffle plate; and a spacer between the focus adapter and the baffle plate that prevents the focus adapter from contacting the baffle plate.

Aspects include the spacer being secured to the baffle plate at each of the plurality of holes. Another aspect includes a housing and a fastener, with the fastener securing a first portion of the spacer between the housing and the baffle plate, and a second portion of the spacer separating the baffle plate from the focus adapter. A further aspect includes the spacer being in the shape of a ring corresponding to a circumference of the baffle plate. A further aspect includes a plurality of spacers positioned around the edge of the baffle plate corresponding to the plurality of the holes. In one aspect, the spacer may be an arc shape. A further aspect includes the spacer having an L-shape. Another aspect includes the thickness of the spacer between the baffle plate and the focus adapter being 0.5 mm. An additional aspect includes the spacer being made of polytetrafluoroethylene, polyether ether ketone, polyoxymethylene, or a polyimide-based plastic.

Another aspect includes a method including: placing a spacer on a baffle plate of an ashing system between the baffle plate and a focus adapter, separating the baffle plate from the focus adapter; and securing the spacer to the baffle plate.

Aspects of the disclosure include, where the spacer is ring shaped, and the baffle plate and the spacer each have a plurality of holes around a circumference thereof, aligning the holes of the spacer with the holes of the baffle plate, and securing the spacer to the baffle plate by fastening the baffle plate and the spacer to a housing of the ashing system through the holes. An additional aspect includes, where the spacer is arc shaped and has at least one hole therethrough, and the baffle has a plurality of holes, securing the spacer to the baffle plate by fastening the baffle plate and the spacer to a housing of the ashing system through the holes. An additional aspect includes the spacer comprising a neck attached to a flange, and aligning the flange of the spacer between the baffle plate and the focus adapter, and securing the spacer by inserting the neck of the spacer in a hole of the baffle plate, and securing the spacer to the baffle plate by fastening the baffle plate and the spacer to a housing of the ashing system through the hole. Another aspect includes, where the baffle plate comprises a plurality of holes around a circumference thereof, securing the spacer to the baffle plate at each hole, and aligning the flange of each spacer between the baffle plate and the focus adapter. A further aspect includes the spacer being made of polytetrafluoroethylene, polyether ether ketone, polyoxymethylene, or a polyimide-based plastic. An additional aspect includes a thickness of each spacer between the baffle plate and the focus adapter being 0.5 mm.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 schematically illustrates a cross-section of an upper chamber of an ashing system, in accordance with an exemplary embodiment;

FIGS. 2A through 2D schematically illustrate various shapes of the spacer, in accordance with exemplary embodiments;

FIGS. 3A and 3B schematically illustrate a cross-section of a baffle plate hole area before and after a spacer is inserted, and FIG. 3C schematically illustrates a plan view of the spacer, in accordance with an exemplary embodiment;

FIGS. 4A through 4C schematically illustrate a cross-sectional view, a plan view, and a side view of the spacer, in accordance with an exemplary embodiment; and

FIGS. 5A and 5B schematically illustrate a cross-sectional view of the spacer attached to a focus adapter and a plan view of the spacer, respectively, in accordance with an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves the current problem of contact between a baffle plate and a focus adapter generating particles during wafer processing because of the friction between the baffle plate and the focus adapter. In accordance with embodiments of the present disclosure, a spacer is inserted between the baffle plate and the focus adapter to prevent the baffle plate and the focus adapter from contacting during wafer processing.

Embodiments of the present disclosure include a housing, a baffle plate including a plurality of holes, a focus adapter between the housing and the baffle plate, a plurality of spacers aligned with the plurality of holes, and a plurality of fasteners securing the plurality of spacers between the baffle plate and the housing, wherein the plurality of spacers isolate the focus adapter from contacting the baffle plate.

Methodology in accordance with embodiments of the present disclosure includes placing a spacer on a baffle plate of an ashing system between the baffle plate and a focus adapter, positioning the spacer such that the spacer prevents the baffle plate from contacting the focus adapter during wafer processing, and securing the spacer to the baffle plate. The spacer may include a neck that is inserted into a hole of the baffle plate, and the spacer may be secured to the baffle plate by fastening the baffle plate and the spacer to a housing of the ashing system through the hole.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

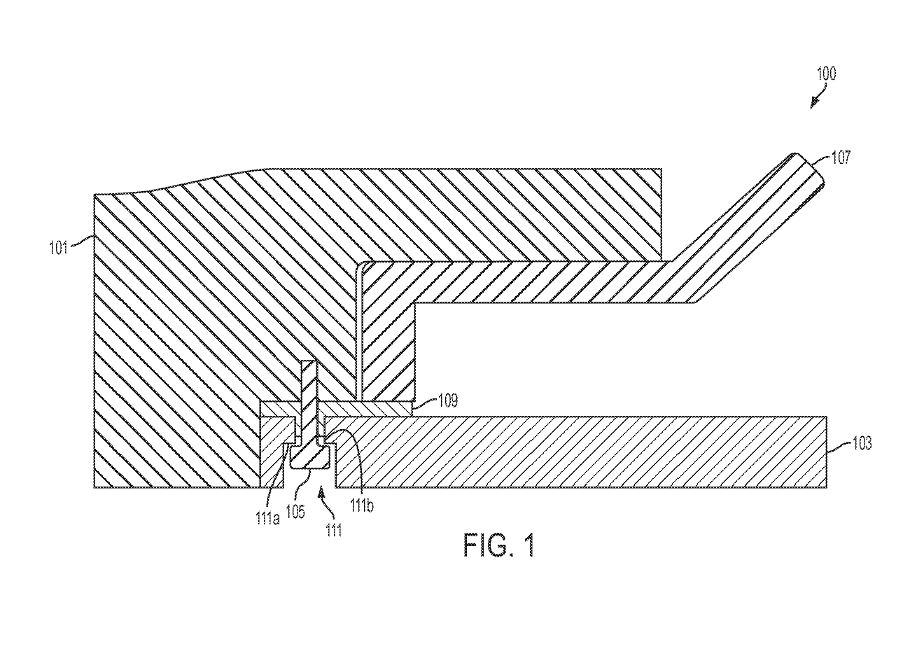

Adverting to FIG. 1, a portion 100 of a cross-section of an upper chamber of an ashing system in accordance with an exemplary embodiment is illustrated. The upper chamber includes a focus adapter housing 101 and a baffle plate 103. The baffle plate 103 may be made of aluminum. The baffle plate 103 may include one or more holes 111 that allow for one or more fasteners 105 that connect the baffle plate 103 to the housing 101. The one or more holes 111 may include a seat 111a and an inner hole 111b that mechanically secure the fastener 105 to the baffle plate 103. The fasteners 105 may be, for example, screws or other mechanical devices for securing the housing 101 to the baffle plate 103. Below the housing 101 is a focus adapter 107, for example made of quartz. According to conventional configurations, the focus adapter 107 comes into contact with the baffle plate 103 during wafer processing causing friction between the focus adapter 107 and the baffle plate 103. Such friction may generate particles that may contaminate the wafer processing and, for example, reduce the mean time between cleans. However, as illustrated in FIG. 1, in accordance with an exemplary embodiment, the setup includes a spacer 109 between the focus adapter 107 and the baffle plate 103. The spacer 109 prevents friction between the focus adapter 107 and the baffle plate 103 during wafer processing, thereby preventing the generation of particles that may contaminate the wafer and the baffle plate.

The spacer 109 may be secured between the housing 101 and the baffle plate 103 by the fastener 105. The spacer 109 may be made from any material that prevents the focus adapter 107 from contacting with the baffle plate 103, and that also withstands the conditions within the upper chamber during wafer processing. Such materials may be, for example, polytetrafluoroethylene (PTFE) (e.g., Teflon®), polyether ether ketone (PEEK), polyoxymethylene (POM) (e.g., Delrin®), and polyimide-based plastics (e.g., Vespel®).

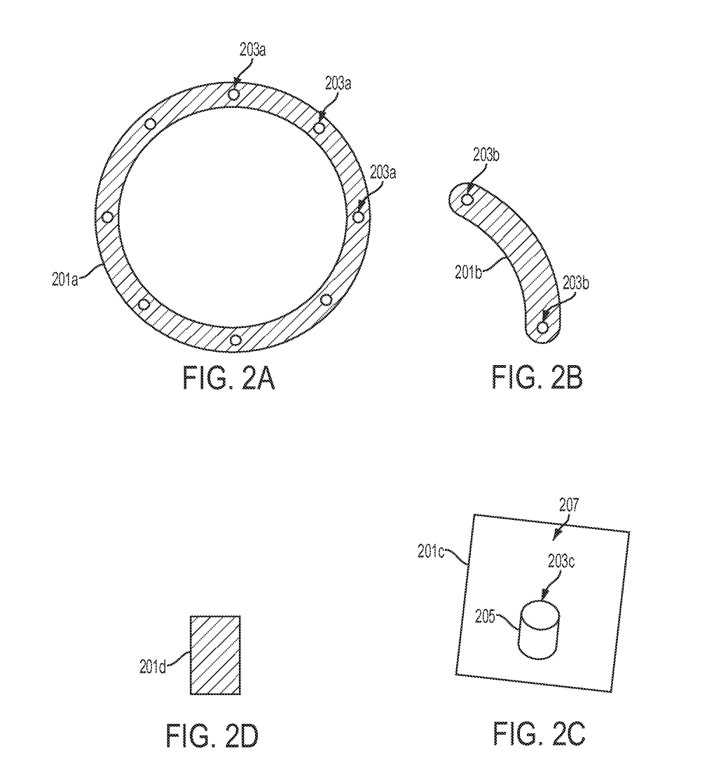

As illustrated in FIGS. 2A through 2D, the spacer 109 may come in various shapes as long as the shape of the spacer 109 does not substantially obstruct the plasma and gas flow on a wafer during wafer processing, and the spacer 109 prevents contact between the baffle plate 103 and the focus adapter 107. As shown in FIG. 2A, the spacer 109 may be in the shape of a ring 201a that lies around the edge of the baffle plate 103. In such a configuration, the spacer 109 may have holes 203a that correspond with the inner holes 111b in the baffle plate 103 and the fasteners 105 that secure the baffle plate 103 to the housing 101. Further, the spacer 109 may be wide enough to be secured between the housing 101 and the baffle plate 103 while still extending far enough towards the center of the baffle plate 103 so as to come into contact with the focus adapter 107 and prevent the focus adapter 107 from contacting the baffle plate 103.

Alternatively, as illustrated in FIG. 2B, the spacer 109 may be in the shape of an arc 201b. Similar to the ring 201a, the arc 201b may have one or more holes 203b to accommodate the fasteners 105 that attach the baffle plate 103 and the spacer 109 to the housing 101. Also, the arc 201b may be secured between the housing 101 and the baffle plate 103 while still wide enough so as to come between the focus adapter 107 and the baffle plate 103 to prevent the focus adapter 107 from contacting the baffle plate 103 during wafer processing. Such arc shaped spacers 109 may be placed around the circumference of the baffle plate 103, attached to the baffle plate 103 at every inner hole 111b.

Adverting to FIG. 2C, the spacer 109 may be in the shape of a L-shaped insert 201c with a hole 203c forming a neck 205 extending from the flat surface 207 of the spacer 109. The neck 205 may be inserted into the inner holes 111b of the baffle plate 103 such that the spacer 109 is seated within the inner holes 111b prior to fastening the spacer 109 and the baffle plate 103 to the housing 101. An L-shaped spacer 109 may be positioned at each inner hole 111b around the circumference of the baffle plate.

As illustrated in FIG. 2D, the spacer 109 may be in the shape of a sticker 201d. The sticker 201d may be in any shape, such as the illustrated rectangle. According to this embodiment, the stickers 201d may be attached around the rim of the focus adapter 107 to prevent contact between the focus adapter 107 and the baffle plate 103. The sticker 201d may have adhesive on one side that faces the focus adapter 107 such that the sticker 201 d may be positioned along the rim of the focus adapter 107 independently from the positions of the inner holes 111b in the baffle plate 103.

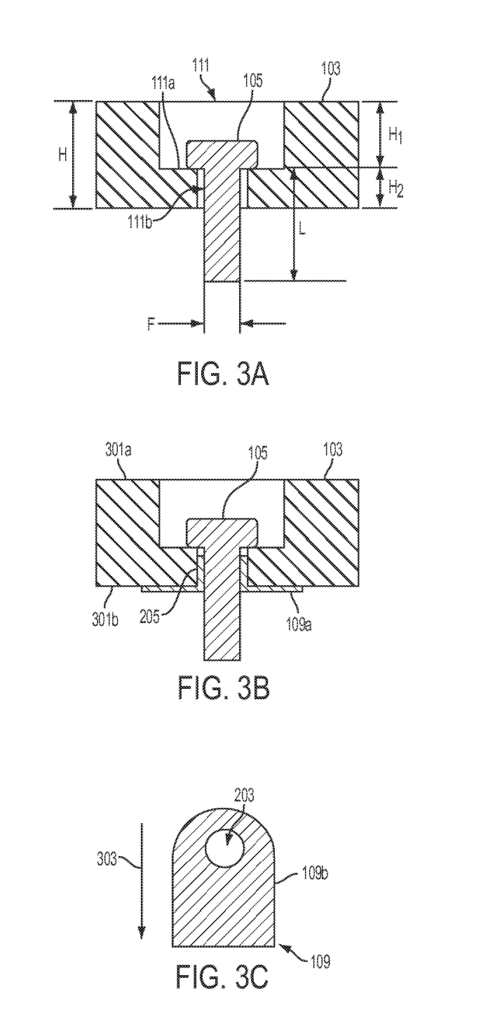

FIG. 3A illustrates the dimensions of the baffle plate 103 and the fastener 105 seated within a hole 111 in the baffle plate 103, according to an exemplary embodiment. As illustrated, the baffle plate 103 may have a thickness H of 9.80 mm to 10.15 mm, for example 10 mm. The depth H₁ of the seat 111a in the hole 111 is 5.4 mm to 6 mm, e.g. 5.5 mm. The thickness H₂ of the baffle plate 103 at the seat 111a in the inner hole 111b is 4.0 mm to 4.6 mm, for example 4.5 mm. The diameter of the hole 111 above the seat 111a may be 6.89 mm to 6.91 mm, e.g., 6.9 mm. The diameter of the inner hole 111b below the seat 111a may be 3.32 mm to 3.46 mm, for example 3.4 mm. The length L of the fastener 105 (e.g., a screw) may be 8.0 mm to 12.0 mm, e.g. 10 mm such that the fastener 105 may extend 3.0 mm to 7.0 mm, such as 6 mm, beyond the baffle plate 103. The diameter F of the fastener 105 may be 2.90 mm to 2.93 mm, e.g., 2.92 mm, to fit within the inner hole 111b.

Adverting to FIG. 3B, the baffle plate 103 may include a frontside surface 301a and a backside surface 301b. An L-shaped spacer 109, such as that shown in FIG. 2C may be inserted around the fastener 105 such that the neck 205 of the spacer 109 is inserted into the backside surface 301b of the inner hole 111b of the baffle plate 103 according to the cross-sectional view of the spacer 109a in FIG. 3B. Further, FIG. 3C illustrates the plan view 109b of the spacer 109 when the spacer 109 is inserted into the hole 111b in the baffle plate 103. The arrow 303 illustrates the direction of the center of the baffle plate 103 relative to the plan view 109b of the spacer 109.

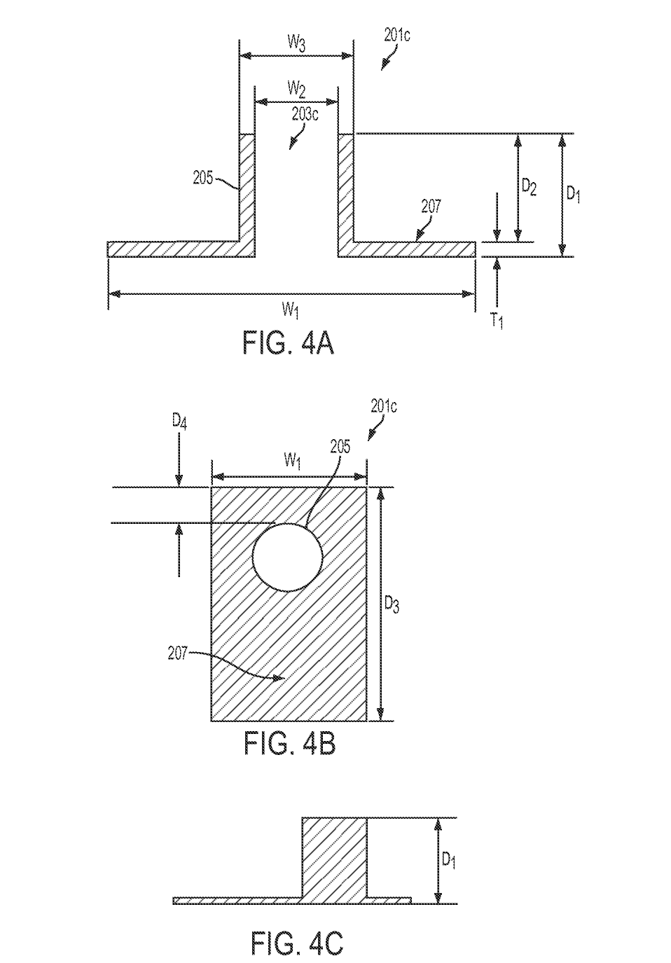

FIGS. 4A through 4C illustrate the various dimensions of an L-shaped insert 201c spacer 109, according to an exemplary embodiment. As illustrated in the cross-sectional view of the spacer 109 in FIG. 4A, the width W₁ of the spacer 109 may be 7.0 mm to 17.0 mm, for example 13 mm. The width W₂ of the hole 203c in the spacer 109 that accepts the fastener 105 may be 2.95 mm to 3.05 mm, e.g. 3 mm, and the width W₃ of the neck 205 of the spacer 109 may be 3.2 mm to 3.35 mm, e.g., 3.3 mm. As discussed above, the hole inner 111b in the baffle plate 103 may be 3.32 mm to 3.46 mm, e.g. 3.4 mm, and the diameter F of the fastener 105 may be 2.90 mm to 2.93 mm, e.g. 2.92 mm such that when the spacer 109 and the fastener 105 are inserted into the inner hole 111b in the baffle plate 103, the fastener 105 and the spacer 109 form a tight fit with the inner hole 111b in the baffle plate 103. The thickness T₁ of the spacer 109 may be 0.2 mm to 1.0 mm, for example 0.5 mm. The height D₁ of the spacer 109 may be 4.5 mm to 5 mm, e.g., 5 mm, and the height D₂ of the neck 205 may be 2 mm to 4.8 mm, e.g., 4.5 mm, such that the height D₂ of the neck 205 and the thickness T₁ of the spacer 109 do not exceed the height D₁ of the spacer 109. The height D₂ of the neck 205 allows the spacer 109 to sit within the inner hole 111b in the baffle plate 103. Further, as illustrated in the plan view of the spacer 109 in FIG. 4B, the length D₃ of the spacer 109 may be 13.0 mm to 15.25 mm, e.g. 15 mm, and the distance D₄ between the edge closest to the neck 205 and the neck 205 may be 3.8 mm to 4.6 mm, for example 4 mm. FIG. 4C illustrates a side view of the spacer 109 illustrating the total height D₁ of the spacer 109, that accounts for the thickness T₁ of the spacer 109 and the height D₂ of the neck 205.

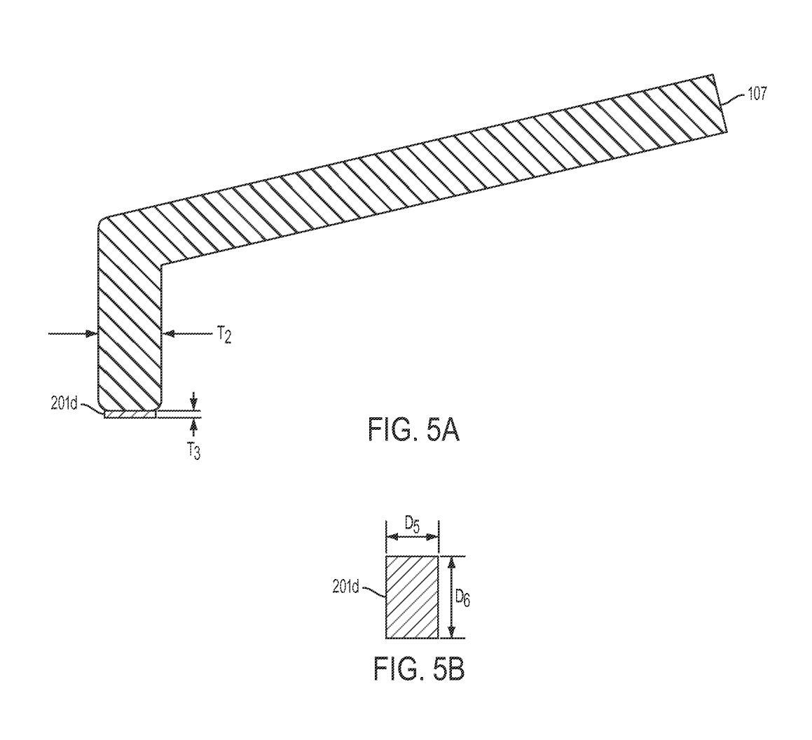

Adverting to FIG. 5A, FIG. 5A illustrates a cross-section of the focus adapter 107 including a spacer 109 attached in the form of a sticker 201d. The thickness T₂ of the focus adapter 107 may be 6.4 mm to 6.6 mm, e.g., 6.5 mm. The thickness T₃ of the sticker 201d may be 0.05 mm to 1.0 mm, e.g., 0.7 mm. In such an embodiment, multiple spacers 109 in the shape of stickers 201d may be positioned along the rim of the focus adapter 107 independently from the positions of the inner holes 111b in the baffle plate 103. However, in one embodiment, spacers 109 in the form of stickers 201d may be positioned on either side of the holes 111b in the baffle plate. FIG. 5B illustrates the plan view of the sticker 201d in FIG. 5A. As illustrated, the sticker 201d may have a width D₅ of 2.5 mm to 5 mm, e.g., 5 mm, and a length D₆ of 4 mm to 7 mm, e.g., 7 mm.

The embodiments of the present disclosure achieve several technical effects, including preventing the focus adapter from contacting the baffle plate during wafer processing, thereby preventing the generation of particles that may contaminate the wafer and the baffle plate. Accordingly, by way of example, the mean time between cleans may be extended, the baffle plates 103 can be reused, particles may not be generated such that there are zero defects, and there are no etch rate issues associated with the baffle plates 103, thereby reducing costs. Embodiments of the present disclosure enjoy utility in various industrial applications as, for example, producing semiconductor wafers used in microprocessors, smart phones, mobile phones, cellular handsets, set-top boxes, DVD recorders and players, automotive navigation, printers and peripherals, networking and telecom equipment, gaming systems, and digital cameras. The present disclosure therefore enjoys industrial applicability associated with any of various types of semiconductor devices.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A device comprising:
a focus adapter;
a baffle plate having a plurality of holes positioned around an edge of the baffle plate; and
a spacer between the focus adapter and the baffle plate that prevents the focus adapter from contacting the baffle plate.

2. The device according to claim 1,
wherein the spacer is secured to the baffle plate at each of the plurality of holes.

3. The device according to claim 1, further comprising:
a housing; and
a fastener,
wherein:
the fastener secures a first portion of the spacer between the housing and the baffle plate, and
a second portion of the spacer separates the baffle plate from the focus adapter.

4. The device according to claim 1, wherein a plurality of the spacers are in the form of stickers that are independently attached to a rim of the focus adaptor away from the plurality of holes.

5. The device according to claim 1, wherein the spacer is a ring shape corresponding to a circumference of the baffle plate.

6. The device according to claim 1, wherein a plurality of the spacers are positioned at the plurality of holes.

7. The device according to claim 6, wherein the plurality of spacers are arc shaped, L-shaped, or a combination thereof.

8. The device according to claim 1, wherein a thickness of the spacer between the baffle plate and the focus adapter is 0.5 mm.

9. The device according to claim 1, wherein the spacer is made of polytetrafluoroethylene, polyether ether ketone, polyoxymethylene, or a polyimide-based plastic.

10. A device comprising:
a housing;
a baffle plate including a plurality of screw holes;
a focus adapter between the housing and the baffle plate;
a plurality of spacers aligned with the plurality of screw holes; and
a plurality of screws securing the plurality of spacers between the baffle plate and the housing,
wherein the plurality of spacers isolate the focus adapter from contacting the baffle plate.

11. The device according to claim 10, wherein each spacer is L-shaped.

12. The device according to claim 10, wherein the spacer is made of polytetrafluoroethylene, polyether ether ketone, polyoxymethylene, or a polyimide-based plastic.

13. The device according to claim 10, wherein a thickness of each spacer between the baffle plate and the focus adapter is 0.5 mm.

14. A method comprising:
placing a spacer on a baffle plate of an ashing system between the baffle plate and a focus adapter, separating the baffle plate from the focus adapter; and
securing the spacer to the baffle plate.

15. The method according to claim 14, wherein the spacer is in the form of a sticker, the method comprising independently attaching a plurality of the spacers to a rim of the focus adaptor and away from a plurality of holes around a circumference of the baffle plate.

16. The method according to claim 14, wherein the spacer is ring shaped, and the baffle plate and the spacer each have a plurality of holes around a circumference thereof, the method comprising:
aligning the holes of the spacer with the holes of the baffle plate; and
securing the spacer to the baffle plate by fastening the baffle plate and the spacer to a housing of the ashing system through the holes.

17. The method according to claim 14, wherein the spacer is arc shaped and has at least one hole therethrough, and the baffle has a plurality of holes, the method comprising securing the spacer to the baffle plate by fastening the baffle plate and the spacer to a housing of the ashing system through the holes.

18. The method according to claim 14, wherein the spacer comprises a neck attached to a flange, the method comprising:
aligning the flange of the spacer between the baffle plate and the focus adapter; and
securing the spacer by:
inserting the neck of the spacer in a hole of the baffle plate; and
fastening the baffle plate and the spacer to a housing of the ashing system through the hole.

19. The method according to claim 18, wherein the baffle plate comprises a plurality of holes around a circumference thereof, the method further comprising:
securing a spacer to the baffle plate at each hole; and
aligning the flange of each spacer between the baffle plate and the focus adapter.

20. The method according to claim 14, wherein the spacer is made of polytetrafluoroethylene, polyether ether ketone, polyoxymethylene, or a polyimide-based plastic, and a thickness of the spacer between the baffle plate and the focus adapter is 0.5 mm.
